(19) United States
(12) Patent Application Publication
(10) Pub. No.: US 2025/0286203 A1
(43) Pub. Date: Sep. 11, 2025

(54) BATTERY PACK

(71) Applicant: TOYOTA JIDOSHA KABUSHIKI KAISHA, Toyota-shi (JP)

(72) Inventors: Shigeyuki INOUE, Toyota-shi (JP); Hiroya TAKAHASHI, Toyota-shi (JP); Hazuki HITOMI, Ohbu-shi (JP); Kazuki SUGIE, Miyoshi-shi (JP)

(73) Assignee: TOYOTA JIDOSHA KABUSHIKI KAISHA, Toyota-shi (JP)

(21) Appl. No.: 19/050,447

(22) Filed: Feb. 11, 2025

(30) Foreign Application Priority Data
Mar. 11, 2024 (JP) 2024-037202

(51) Int. Cl. H01M 50/325; B60K 1/04; H01M 50/249

(52) U.S. Cl. CPC H01M 50/325; B60K 1/04; H01M 50/249; B60K 2001/0438

(57) ABSTRACT

A battery pack according to the present disclosure is to be mounted on a vehicle, and includes, in a state in which the battery pack is mounted on a vehicle cabin lower side of the vehicle: a plurality of battery cells stacked in a front-rear direction of the vehicle; and a case that accommodates the battery cells. Each of the battery cells includes a cell opening portion and a cell valve. The cell opening portion is provided in a bottom surface. The cell valve is provided in the cell opening portion. The case includes a case opening portion communicating with the cell opening portion. The cell opening portion includes a first side and a second side that faces the first side. The cell valve includes a first door and a second door. The first door is provided on the first side. The second door is provided on the second side.

### CROSS-REFERENCE TO RELATED APPLICATION

This application claims priority to Japanese Patent Application No. 2024-037202 filed on Mar. 11, 2024, incorporated herein by reference in its entirety.

### BACKGROUND

### 1. Technical Field

The present disclosure relates to a battery pack.

### 2. Description of Related Art

In a battery module disclosed in Japanese Unexamined Patent Application Publication No. 2023-065217, a plurality of battery cells is stacked and disposed. Further, a casing accommodates the plurality of battery cells aligned in the lateral direction. Further, a smoke exhaust cover is positioned between the plurality of battery cells and an upper plate of the casing. In the upper surface of each of the plurality of battery cells, a pressure release valve is provided. For example, when a short-circuit is caused in the battery cell, high-pressure gas or debris may be generated and released from the pressure release valve. In the following, a phenomenon in which gas or debris is released from the pressure release valve of the battery cell is sometimes simply referred to as “smoke emission”. The smoke exhaust cover can effectively guide the gas or the debris emitted from the battery cell at the time of smoke emission.

### SUMMARY

The inventors of the subject application have found the following problem. The inventors of the subject application have recalled a battery pack in which a cell valve is provided in a bottom surface of each of a plurality of battery cells. A case accommodates the plurality of battery cells aligned in the lateral direction. The case includes a case valve that faces the cell valve. In such a battery pack, at the time of smoke emission, debris is emitted. Then, the debris passes through the cell valve and the case valve so as to be discharged. However, there has been a possibility that the cell valve becomes clogged with the debris.

The present disclosure has been made in view of the above-mentioned problem, and provides a battery pack that can reduce the possibility of the cell valve becoming clogged with debris.

A battery pack according to the present disclosure is a battery pack to be mounted on a vehicle, and includes, in a state in which the battery pack is mounted on a vehicle cabin lower side of the vehicle: a plurality of battery cells stacked in a front-rear direction of the vehicle; and a case that accommodates the battery cells. Each of the battery cells includes a cell opening portion and a cell valve. The cell opening portion is provided in a bottom surface of each of the battery cells. The cell valve is provided in the cell opening portion. The case includes a case opening portion communicating with the cell opening portion. The cell opening portion includes a first side and a second side that faces the first side. The cell valve includes a first door and a second door. The first door is provided on the first side. The second door is provided on the second side. A space surrounded by the first door, the second door, and the cell opening portion has a substantially H-shape in the bottom surface.

In the above-mentioned battery pack, the first door and the second door may each be rotatable about an axis extending along a longitudinal direction of each of the battery cells.

In the above-mentioned battery pack, the space surrounded by the first door, the second door, and the cell opening portion may have an area that is equal to or larger than a sum of areas of the first door and the second door in the bottom surface.

According to the present disclosure, it is possible to reduce the possibility of the cell valve becoming clogged with debris.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view of one configuration example of a battery pack according to a first embodiment;

FIG. 2 is a side view of a battery module according to the first embodiment;

FIG. 3 is a bottom view of the battery module according to the first embodiment;

FIG. 4 is a bottom view of one configuration example of a cell valve according to the first embodiment;

FIG. 5 is a bottom view of a case according to the first embodiment;

FIG. 6 is an enlarged view of a region 22A illustrated in FIG. 5;

FIG. 7 is a schematic sectional view of the battery module taken along the cutting line VII-VII illustrated in FIG. 6; and

FIG. 8 is a bottom view of one modification example of the cell valve according to the first embodiment.

### DETAILED DESCRIPTION OF EMBODIMENTS

Hereinafter, specific embodiments to which the present disclosure is applied are described in detail with reference to the drawings. However, the present disclosure is not limited to the following embodiments. Further, for the sake of clear description, the following description and drawings are simplified as appropriate.

### First Embodiment

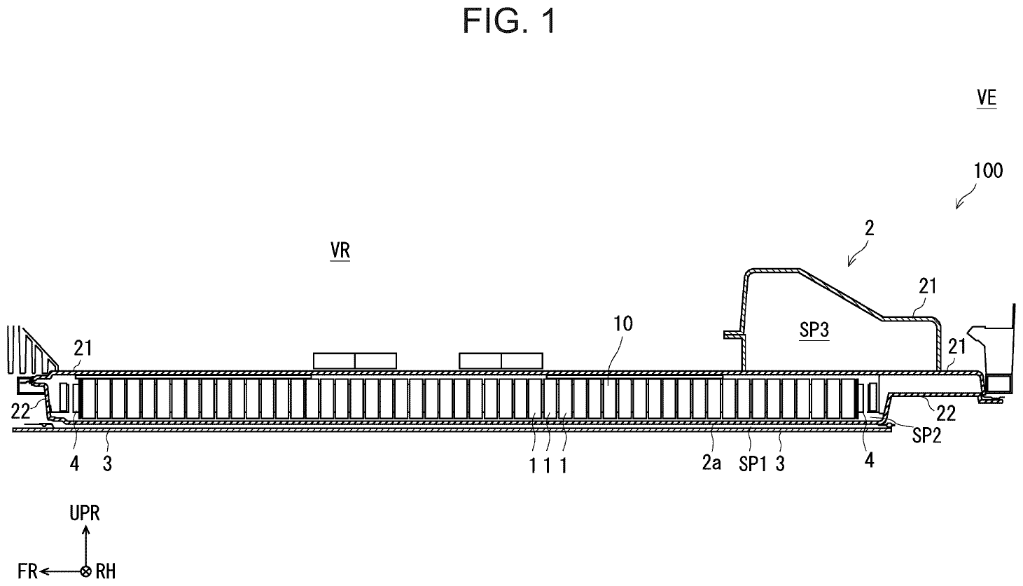

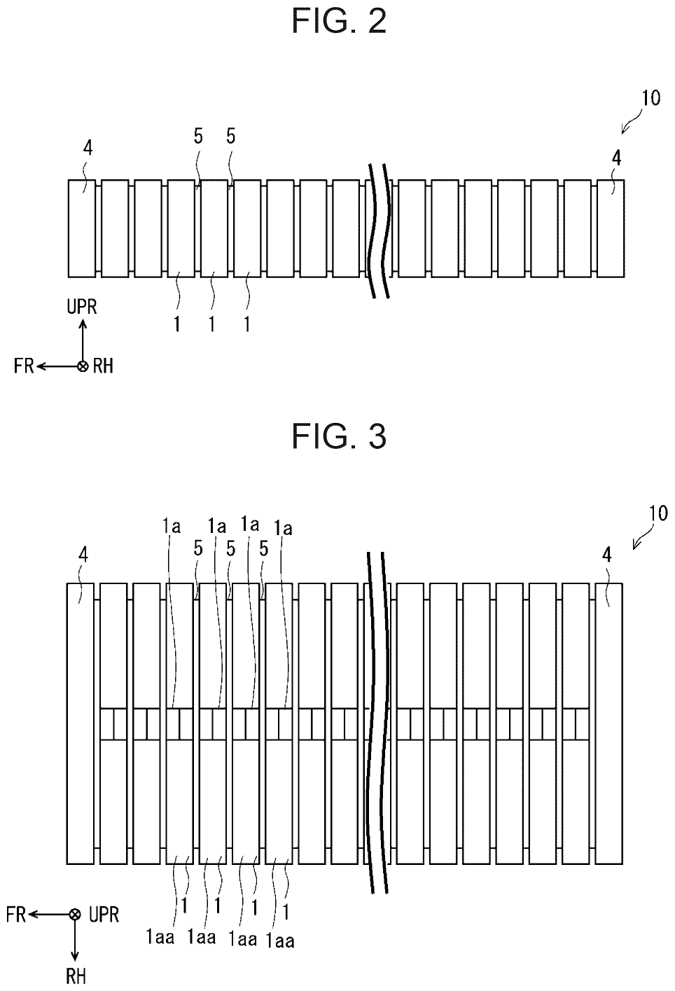

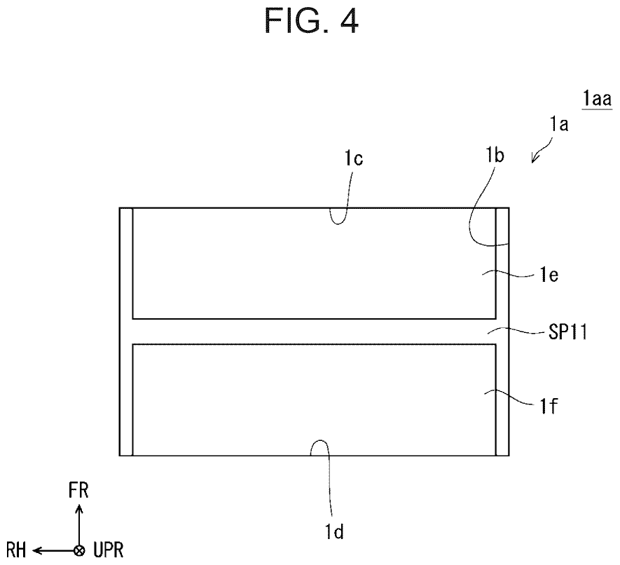

A first embodiment is described with reference to FIG. 1 to FIG. 7. FIG. 1 is a schematic sectional view of one configuration example of a battery pack according to a first embodiment. FIG. 2 is a side view of a battery module according to the first embodiment. FIG. 3 is a bottom view of the battery module illustrated in FIG. 2. FIG. 4 is a bottom view of one configuration example of a cell valve according to the first embodiment.

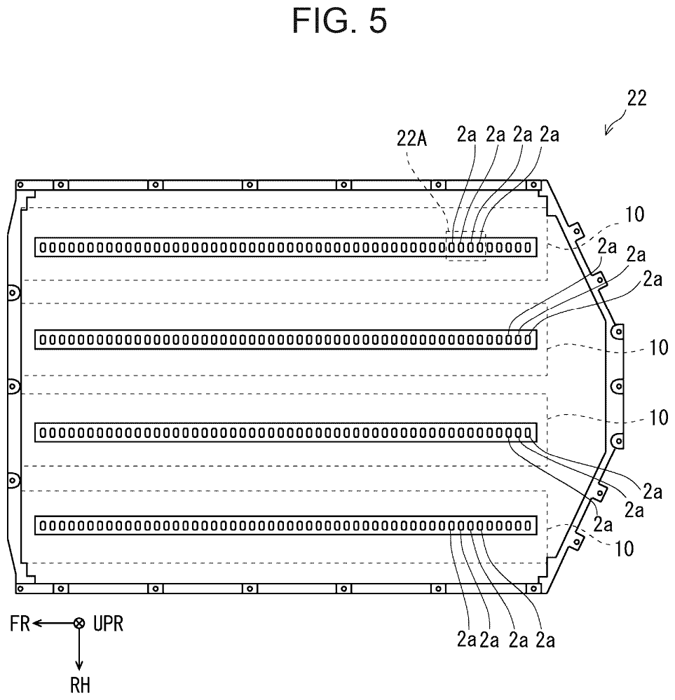

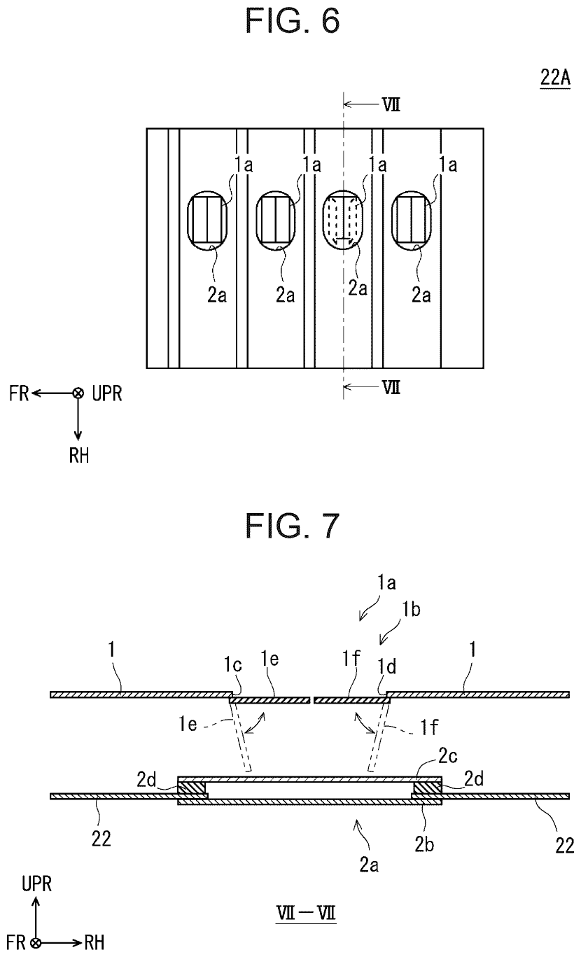

FIG. 5 is a bottom view of a case according to the first embodiment. FIG. 6 is an enlarged view of a region 22A illustrated in FIG. 5. FIG. 7 is a schematic sectional view of the battery module taken along the cutting line VII-VII illustrated in FIG. 6.

It is to be noted that, as a matter of course, the three dimensional coordinates shown in FIG. 1 and other drawings are illustrated for convenience of explanation regarding a positional relation among components. Usually, a plus direction of a UPR axis represents a vertically upward direction in a vehicle VE, a plus direction of a FR axis represents a forward direction in the vehicle VE, and a plus direction of a RH axis represents a rightward direction in the vehicle VE. Further, a plane including the FR axis and the RH axis represents a horizontal plane, and these are the same throughout the drawings.

As illustrated in FIG. 1, a battery pack 100 includes battery modules 10, a case 2, and a shared panel 3. The battery pack 100 is to be mounted on the vehicle VE. The battery pack 100 is disposed on the lower side of a vehicle cabin VR of the vehicle VE.

The case 2 accommodates the battery modules 10. The case 2 includes a lower case 22 and an upper case 21. The shared panel 3 is disposed on the lower side of the case 2. The shared panel 3 can receive input from a road while the vehicle VE travels. The shared panel 3 is disposed with a predetermined interval from the case 2. The shared panel 3 preferably has a size that can cover the case 2. The case 2 and the shared panel 3 are preferably configured with use of a metal material. Examples of the metal material include iron and steel and an aluminum alloy.

A smoke exhaust space SP1 is formed between the shared panel 3 and the case 2. At the time of smoke emission, gas or debris emitted from the battery module 10 preferably passes through the smoke exhaust space SP1 to be discharged to the outside of the vehicle VE.

A cell space SP2 is formed between the lower case 22 and the upper case 21. The battery modules 10 are accommodated in the cell space SP2.

An equipment space SP3 is preferably formed on the inner side of the upper case 21. In the equipment space SP3, equipment configuring the vehicle VE is preferably disposed.

As illustrated in FIG. 2, the battery modules 10 each include a plurality of battery cells 1 and two end plates 4. The plurality of battery cells 1 is stacked in the FR axis direction through intermediation of a heat insulating material 5. The two end plates 4 sandwich the plurality of battery cells 1 through intermediation of the heat insulating material 5. As illustrated in FIG. 3, a cell valve 1a is provided in a bottom surface 1aa of the battery cell 1. The example of the cell valve 1a illustrated in FIG. 3 is provided near a center in the bottom surface 1aa of the battery cell 1. A positive terminal and a negative terminal are preferably provided respectively on both side surfaces of the battery cell 1.

As illustrated in FIG. 4, the battery cell 1 includes a cell opening portion 1b. The battery cells 1 preferably include a plurality of cell opening portions 1b. The cell opening portion 1b is provided in the bottom surface 1aa of the battery cell 1. The shape of the cell opening portion 1b is preferably, in bottom view, for example, a rectangular shape, an elliptical shape, a racetrack shape (an oval shape), or the like. The shape of the example of the cell opening portion 1b illustrated in FIG. 4 is a rectangular shape. The cell opening portion 1b includes a first side 1c and a second side 1d. The first side 1c and the second side 1d face each other and extend in parallel with each other. The cell valve 1a includes a first door 1e and a second door 1f. The first door 1e and the second door 1f are double-door type swinging doors. The first door 1e and the second door 1f each preferably have, in bottom view, a substantially rectangular shape. The first door 1e is provided on the first side 1c so as to be rotatable about an axis extending on the first side 1c. The second door 1f is provided on the second side 1d so as to be rotatable about an axis extending on the second side 1d. The first side 1c and the second side 1d each preferably extend along the longitudinal direction (in this case, the RH axis direction) of the battery cell 1. That is, the first door 1e and the second door 1f are each rotatable about the axis extending along the longitudinal direction of the battery cell 1. The first door 1e is rotatable to the lower case 22 side (in this case, a minus direction of the UPR axis) illustrated in FIG. 1 from the center of the cell opening portion 1b. The second door 1f is rotatable to the lower case 22 side from the center of the cell opening portion 1b. A space SP11 is surrounded by the first door 1e, the second door 1f, and the cell opening portion 1b. The space SP11 is formed in an H-shape in the bottom surface 1aa of the battery cell 1. The space SP11 surrounded by the first door 1e, the second door 1f, and the cell opening portion 1b preferably has an area that is equal to or 20 larger than a sum of areas of the first door 1e and the second door 1f in the bottom surface 1aa.

As illustrated in FIG. 5, the lower case 22 includes a case opening portion 2a. The lower case 22 preferably includes a plurality of case opening portions 2a. The shape of the case opening portion 2a is preferably, in bottom view, for example, a rectangular shape, an elliptical shape, a racetrack shape, or the like. The shape of the example of the case opening portion 2a illustrated in FIG. 5 is a racetrack shape. The case opening portions 2a are aligned along the longitudinal direction (in this case, the FR axis direction) of the battery module 10. Specifically, each case opening portion 2a is preferably aligned so as to face each cell opening portion 1b. Each case opening portion 2a and each cell opening portion 1b are preferably communicated with each other.

As illustrated in FIG. 6, in bottom view of a region 22A of the lower case 22, the case opening portion 2a encompasses the cell valve 1a. As illustrated in FIG. 7, the case opening portion 2a is preferably covered with a lid 2b and a lid 2c. The lid 2c may be bonded to the case opening portion 2a via an adhesive 2d. The lid 2c is made of, for example, a resin material. The lid 2c preferably has a predetermined melting temperature and mechanical strength such that debris derived from smoke emission of the battery cell 1 can pass through the lid 2c. Further, the lid 2c preferably ensures the airtightness required for the lower case 22.

Here, when smoke emission occurs in the battery cell 1, high-pressure debris is generated inside of the battery cell 1, and the debris reaches the cell valve 1a. Then, the cell valve 1a is opened. Specifically, the first door le and the second door 1f are opened. More specifically, the first door 1e is rotated to the lower case 22 side from the center of the cell opening portion 1b. The second door 1f is rotated to the lower case 22 side from the center of the cell opening portion 1b. Accordingly, the debris passes through the cell opening portion 1b and the case opening portion 2a so as to be discharged to the outside of the vehicle VE. Accordingly, it is possible to prevent the cell valve 1a from becoming clogged with the debris.

Further, the first door 1e and the second door 1f according to this embodiment are each rotatable about an axis extending along the longitudinal direction of the battery cell 1. An axis of the first door 1e and an axis of the second door 1f preferably extend along the longitudinal direction of the battery cell 1. With such a configuration, the debris easily passes through the cell valve 1a, and it is possible to further prevent the cell valve 1a from becoming clogged with the debris.

Further, the area of the space SP11 surrounded by the first door 1e, the second door 1f, and the cell opening portion 1b according to this embodiment is equal to or larger than the sum of the areas of the first door 1e and the second door 1f in the bottom surface 1aa. With such a configuration, the debris easily passes through the cell valve 1a, and it is possible to further prevent the cell valve 1a from becoming clogged with the debris.

### One Modification Example

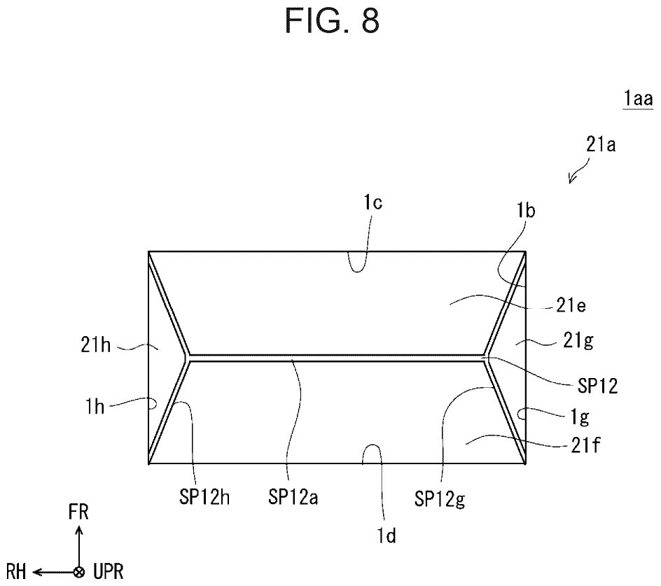

Next, with reference to FIG. 8, one modification example of the cell valve 1a is described. FIG. 8 is a bottom view of one modification example of the cell valve illustrated in FIG. 5.

As illustrated in FIG. 8, a cell valve 21a includes a first door 21e, a second door 21f, and protruding portions 21g, 21h.

The first door 21e and the second door 21f are double-door type swinging doors. The first door 21e and the second door 21f each preferably have, in bottom view, a substantially trapezoidal shape. The base on the side of the center of the cell opening portion 1b in the substantially trapezoidal shape of the first door 21e is preferably shorter than the base on the first side 1c side in the substantially trapezoidal shape. The base on the side of the center of the cell opening portion 1b in the substantially trapezoidal shape of the second door 21f is shorter than the base on the second side 1d side in the substantially trapezoidal shape. The first door 21e is provided on the first side 1c so as to be rotatable about an axis extending on the first side 1c. The second door 21f is provided on the second side 1d so as to be rotatable about an axis extending on the second side 1d. The first door 21e is rotatable to the lower case 22 side (in this case, the minus direction of the UPR axis) illustrated in FIG. 1 from the center of the cell opening portion 1b. The second door 21f is rotatable to the lower case 22 side from the center of the cell opening portion 1b.

The example of the cell opening portion 1b illustrated in FIG. 8 includes a third side 1g and a fourth side 1h. The third side 1g and the fourth side 1h face each other and are parallel with each other. The third side 1g and the fourth side 1h intersect with the first side 1c, and also intersect with the second side 1d. The protruding portion 21g protrudes from the third side 1g to the center of the cell opening portion 1b. The protruding portion 21h protrudes from the fourth side 1h to the center of the cell opening portion 1b. The protruding portions 21h, 21g each preferably have, in bottom view, a substantially triangular shape.

A space SP12 is surrounded by the first door 21e, the second door 21f, the protruding portions 21g, 21h, and the cell opening portion 1b. The space SP12 is formed in a substantially H-shape in the bottom surface 1aa of the battery cell 1. The space SP12 includes a center portion SP12a, a first side portion SP12g, and a second side portion SP12h. The center portion SP12a extends in the RH axis direction at the center of the cell opening portion 1b. The first side portion SP12g and the second side portion SP12h each extend in a substantially V-shape. Specifically, the first side portion SP12g extends from one end of the center portion SP12a to a part in which the third side 1g and the first side 1c intersect with each other and a part in which the third side 1g and the second side 1d intersect with each other. The second side portion SP12h extends from another end of the center portion SP12a to a part in which the fourth side 1h and the first side 1c intersect with each other and a part in which the fourth side 1h and the second side 1d intersect with each other.

Here, when smoke emission occurs in the battery cell 1, high-pressure debris is generated inside of the battery cell 1, and the debris reaches the cell valve 21a. Then, the cell valve 21a is opened. Specifically, the first door 21e and the second door 21f are opened. More specifically, the first door 21e is rotated to the lower case 22 side from the center of the cell opening portion 1b. The second door 21f is rotated to the lower case 22 side from the center of the cell opening portion 1b. Accordingly, the debris passes through the cell opening portion 1b and the case opening portion 2a so as to be discharged to the outside of the vehicle VE. Accordingly, it is possible to prevent the cell valve 21a from becoming clogged with the debris.

It is to be noted that the present disclosure is not limited to the above-mentioned embodiments, and can be modified as appropriate without departing from the gist. Further, the present disclosure may be embodied by combining the above-mentioned embodiments and examples thereof as appropriate.

What is claimed is:

1. A battery pack to be mounted on a vehicle, the battery pack comprising, in a state in which the battery pack is mounted on a vehicle cabin lower side of the vehicle:
a plurality of battery cells stacked in a front-rear direction of the vehicle; and
a case that accommodates the battery cells, wherein
each of the battery cells includes a cell opening portion and a cell valve,
the cell opening portion is provided in a bottom surface of each of the battery cells,
the cell valve is provided in the cell opening portion,
the case includes a case opening portion communicating with the cell opening portion,
the cell opening portion includes a first side and a second side that faces the first side,
the cell valve includes a first door and a second door,
the first door is provided on the first side,
the second door is provided on the second side, and
a space surrounded by the first door, the second door, and the cell opening portion has
a substantially H-shape in the bottom surface.

2. The battery pack according to claim 1, wherein the first door and the second door are each rotatable about an axis extending along a longitudinal direction of each of the battery cells.

3. The battery pack according to claim 1, wherein the space surrounded by the first door, the second door, and the cell opening portion has an area that is equal to or larger than a sum of areas of the first door and the second door in the bottom surface.
